(19) United States
(12) Patent Application Publication
(10) Pub. No.: US 2020/0320021 A1
(43) Pub. Date: Oct. 8, 2020

(54) ACCESS MANAGEMENT APPARATUS AND ACCESS MANAGEMENT METHOD

(71) Applicant: CANON KABUSHIKI KAISHA, Tokyo (JP)

(72) Inventor: Xin Li, Tokyo (JP)

(21) Appl. No.: 16/834,516

(22) Filed: Mar. 30, 2020

(30) Foreign Application Priority Data
Apr. 2, 2019 (JP) 2019-070784

(51) Int. Cl. G06F 12/14; G06F 12/02; G06F 9/48; G06F 9/54; G06F 13/16

(52) U.S. Cl. CPC G06F 12/1441; G06F 12/0246; G06F 13/1605; G06F 9/546; G06F 9/4881

(57) ABSTRACT

An access management apparatus is provided that manages an access to a memory that includes a plurality of access regions in which an access stop period is regularly generated. The access management apparatus includes an acquisition unit configured to acquire schedule information for the access stop period, and a transmission unit configured to select one access request from among a plurality of access requests to the memory based on the schedule information, and transmit the selected access request to the memory.

### BACKGROUND

### Field

The present disclosure relates to an access management apparatus that manages an access to a memory including a plurality of access regions in which an access stop period is regularly generated.

### Description of the Related Art

In recent years, the processing speeds of smartphones, personal computers, and digital cameras have been getting higher, and the capacity of memories has been getting larger. A growing number of high-speed and low-cost semiconductor memories have been greatly used as a memory. In particular, a dynamic random access memory (DRAM) with low price per bit is often used as a program memory or a data memory. A DRAM needs to be refreshed at a constant frequency for holding stored content, and access to the memory is prohibited during the refreshing. This contributes to a performance decline in memory access. An advance of the DRAM technology provides the function of refreshing the DRAM for each bank region, and enables an access to a bank region that is not currently being refreshed while another bank region is being refreshed.

To improve contention between a refresh request and an access request of each bank region, Japanese Patent Application Laid-Open No. H11-134292 discusses a method for prohibiting an access request to a bank region being refreshed. In addition, Japanese Patent Application Laid-Open No. H11-167519 discusses a method for temporarily saving an access request into a buffer.

The technique discussed in Japanese Patent Application Laid-Open No. H11-134292 notifies a refresh state of a bank region to a master, and the master prohibits an access if the bank region is being refreshed. The technique discussed in Japanese Patent Application Laid-Open No. H11-134292, however, delays an access request until the refreshing of the bank region is completed. In processing in which a plurality of accesses is expected to be completed in a short period of time, the completion of processing is delayed by the influence of the refreshing, and this generates an issue of performance decline.

In addition, the techniques discussed in Japanese Patent Application Laid-Open No. H11-167519 includes a save buffer for saving an access request, and temporarily saves an access request to a bank region currently being refreshed, into the save buffer. However, recent image data can have high image quality and high resolution, and a large number of access requests can often be generated in a short period of time. In such circumstances, if all access requests generated during refreshing are to be temporarily saved, a large-capacity save buffer may be required. This can produce disadvantages in terms of the required circuit size and power consumption.

### SUMMARY

According to various embodiments, an access management apparatus is provided that manages an access to a memory including a plurality of access regions in which an access stop period is regularly generated. The access management apparatus includes an acquisition unit configured to acquire schedule information for the access stop period, and a transmission unit configured to select one access request from among a plurality of access requests to the memory based on the schedule information, and transmit the selected access request to the memory.

Further features will become apparent from the following description of embodiments with reference to the attached drawings.

### BRIEF DESCRIPTION OF THE DRAWINGS

FIG. 1 is a configuration diagram of a memory bus system.

FIG. 2 is a configuration diagram of an access stop control unit according to a first embodiment.

FIG. 3 is a configuration diagram of an access order control unit according to the first embodiment.

FIG. 4 is a waveform chart illustrating a behavior of the memory bus system according to the first embodiment.

FIG. 5 is a configuration diagram of another access order control unit according to the first embodiment.

FIG. 6 is a configuration diagram of an access order control unit according to a second embodiment.

FIG. 7 is a waveform chart illustrating a behavior of a memory bus system according to the second embodiment.

FIG. 8 is a configuration diagram of an access stop control unit according to a third embodiment.

FIG. 9 is a waveform chart illustrating a behavior of a memory bus system according to the third embodiment.

FIG. 10 is a configuration diagram of an access stop control unit according to a fourth embodiment.

FIG. 11 is a waveform chart illustrating a behavior of a memory bus system according to the fourth embodiment.

### DESCRIPTION OF THE EMBODIMENTS

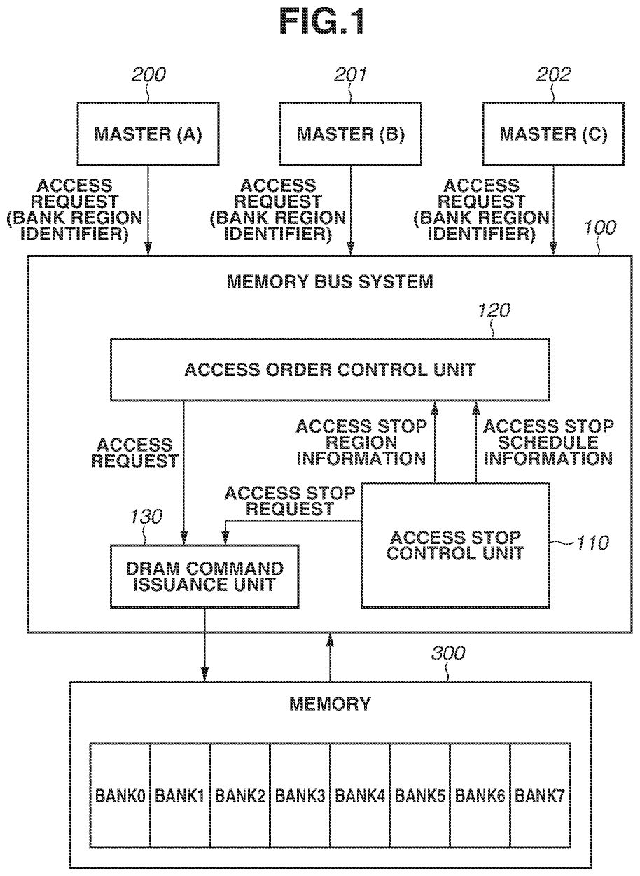

A first embodiment of the present disclosure will be described below. FIG. 1 is a configuration diagram of a memory bus system 100 according to the present embodiment. The memory bus system 100 functions as an access management apparatus that manages an access to a memory. Masters 200 to 202 and a memory 300 are connected via the memory bus system 100. The memory 300 is a dynamic random access memory (DRAM) and includes a plurality of bank regions as access regions. The memory 300 can be regularly refreshed for each bank region. During refreshing, the bank region enters an access stop period.

In the present embodiment, the masters 200 to 202 each issue an access request to the memory bus system 100. The access request includes a bank region identifier for identifying a bank region. The memory bus system 100 generates a memory command based on the access requests received from the masters 200 to 202, and transmits the memory command to a corresponding bank region of the memory 300.

An access stop control unit 110 transmits an access stop request (refresh request) to a DRAM command issuance unit 130 to refresh each bank region of the memory 300 at regular intervals based on a refresh restriction of the DRAM. The access stop control unit 110 further transmits, as access stop region information, information indicating a bank region currently being refreshed, to an access order control unit 120. The access stop control unit 110 further transmits access stop schedule information to the access order control unit 120. In the present embodiment, the access stop schedule information includes the information indicating the bank regions to be refreshed, and the order of refreshment of the bank regions to be refreshed. In the present embodiment, the access stop schedule information will be described as access stop order information.

The access order control unit 120 selects an optional one access request to a bank region other than the bank region included in the access stop region information, from among the plurality of access requests received from the masters 200 to 202, and transfers the selected access request to the DRAM command issuance unit 130. In addition, the access order control unit 120 acquires the access stop order information from the access stop control unit 110. In the present embodiment, the access order control unit 120 changes a priority of a bank region to be refreshed, to a different priority in accordance with the access stop order information. A priority set to a bank region to be refreshed earlier is higher than a priority of a bank region to be refreshed later. The lowest priority is set to a bank region that has not been transmitted.

The DRAM command issuance unit 130 generates a DRAM command and issues the DRAM command to a corresponding bank region based on the access request from the access order control unit 120 or the access stop request (refresh request) from the access stop control unit 110.

In accordance with the issued DRAM command, the memory 300 enables a memory access to each bank region or refreshes each bank region.

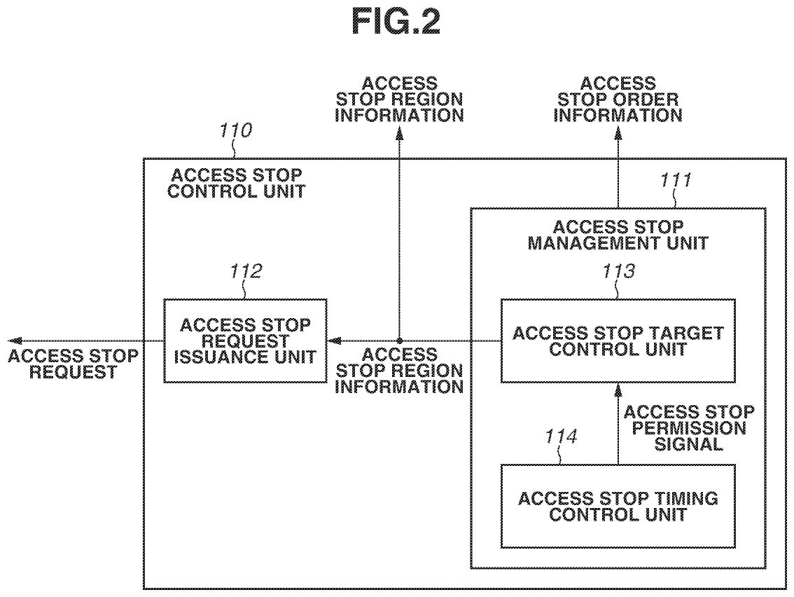

FIG. 2 is a configuration diagram of the access stop control unit 110 according to the first embodiment.

The access stop control unit 110 includes an access stop management unit 111 and an access stop request issuance unit 112.

The access stop management unit 111 manages a refresh issuance target and a refresh issuance timing of each bank region. Thus, the access stop management unit 111 includes an access stop target control unit 113 that manages a refresh issuance target, and an access stop timing control unit 114 that manages an issuance timing, and controls a refresh operation that can satisfy the refresh restriction of the DRAM. In the present embodiment, the memory including eight banks is refreshed in the order of a bank 0, a bank 1, a bank 2, a bank 3, a bank 4, a bank 5, a bank 6, and a bank 7.

To implement the present embodiment, the access stop target control unit 113 holds information regarding a bank region that has been lastly refreshed. Upon receiving an access stop permission signal from the access stop timing control unit 114, the access stop target control unit 113 notifies a bank region to be refreshed next, to the access stop request issuance unit 112 and the access order control unit 120 as the access stop region information. The access stop target control unit 113 then transmits bank regions corresponding to a threshold that are generated after that, and the order thereof to the access order control unit 120 as the access stop order information.

The access stop timing control unit 114 includes a counter for measuring a refresh interval from when a certain bank region defined by a DRAM specification is refreshed to when a following bank region is refreshed. Each time a refresh interval is measured, the access stop timing control unit 114 transmits an access stop permission signal to the access stop target control unit 113.

The access stop request issuance unit 112 receives access stop region information including a bank region to be refreshed, from the access stop management unit 111, decodes the bank region, and transmits a refresh request to the DRAM command issuance unit 130.

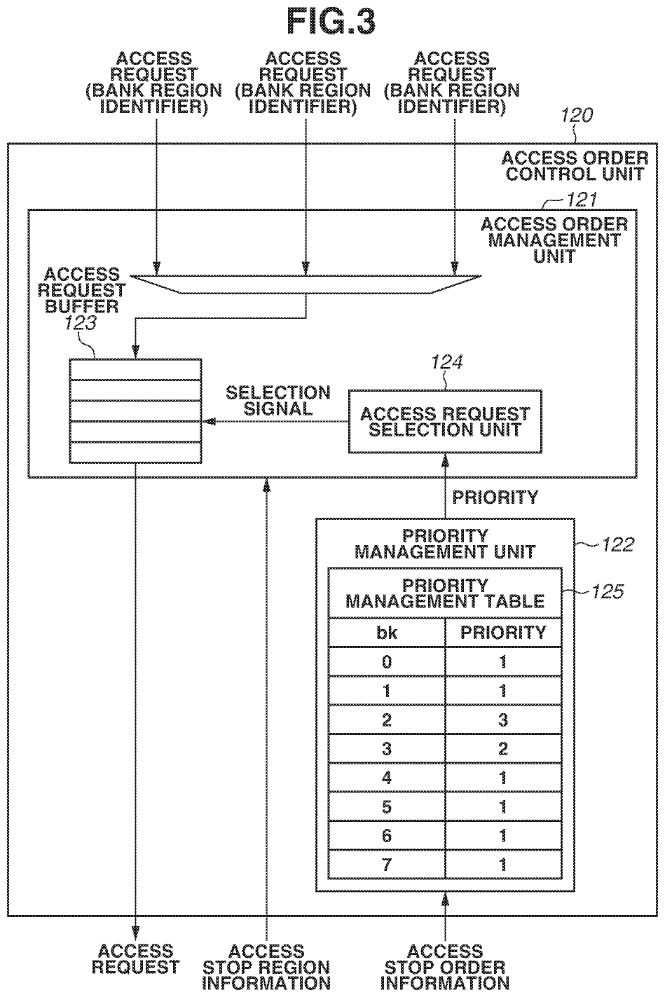

FIG. 3 is a configuration diagram of the access order control unit 120 according to the first embodiment.

The access order control unit 120 includes an access order management unit 121 and a priority management unit 122.

The access order management unit 121 holds a plurality of access requests in an access request buffer 123, selects one access request from the access request buffer 123 in accordance with a priority from the priority management unit 122, and transfers the access request to the DRAM command issuance unit 130. If the access order management unit 121 receives access stop region information indicating a bank region currently being refreshed, from the access stop management unit 111, the access order management unit 121 controls an access request to the bank region so as not to be selected.

The priority management unit 122 includes a priority management table 125 that manages priorities of the respective bank regions. When the priority management unit 122 receives access stop order information from the access stop management unit 111, the priority management unit 122 sets the priorities of the bank regions in the priority management table 125. In addition, the priority management unit 122 constantly transmits a priority in the priority management table 125 to an access request selection unit 124.

The access request selection unit 124 notifies a selection signal to the access request buffer 123 based on the priority received from the priority management unit 122, selects one access request, and draws out the selected access request from the access request buffer 123. The access request selection unit 124 selects access requests in the descending order of priority. If the priorities are the same, the access request selection unit 124 selects an access request based on the order in which the access requests are stored in the access request buffer 123.

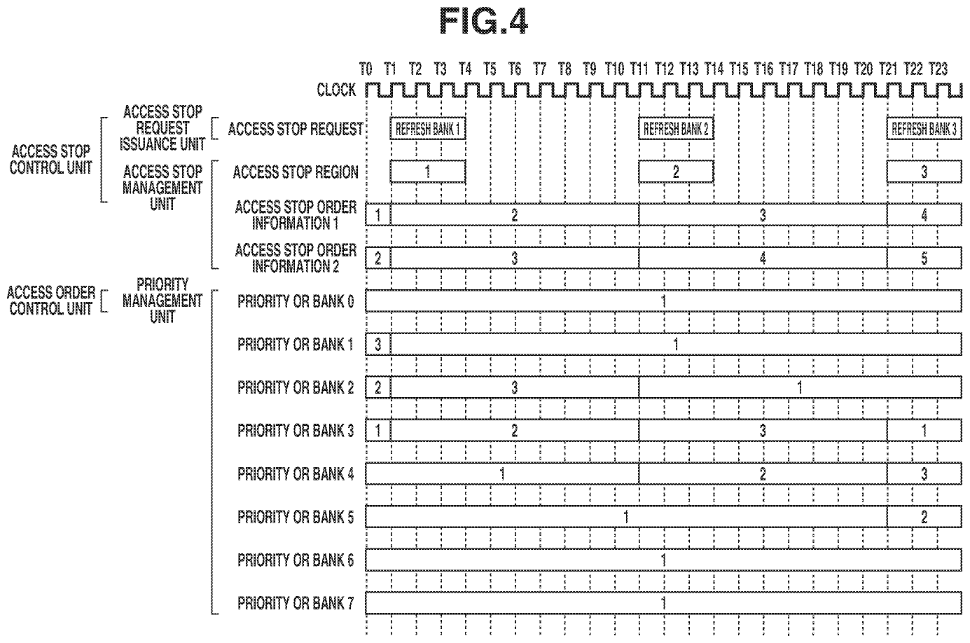

FIG. 4 is a waveform chart illustrating a behavior of the memory bus system according to the first embodiment. In this waveform chart, the access stop control unit 110 transmits pieces of access stop order information corresponding to a threshold, to the access order control unit 120. In the present embodiment, the description will be provided assuming that the threshold is set to 2.

At a time T1,the access stop target control unit 113 transmits, as the access stop region information, information indicating the bank 1 to the access stop request issuance unit 112, and issues refreshing of the bank 1 to the memory 300 via the DRAM command issuance unit 130. At the same time, the access stop target control unit 113 transmits information indicating the bank 1 as the access stop region information to the access order control unit 120. Furthermore, the access stop target control unit 113 transmits, as the access stop order information, information indicating the banks 2 and 3 to be refreshed after the bank 1 to the access order control unit 120.

At the time T1, the priority management unit 122 of the access order control unit 120 receives access stop order information 1 (bank 2) and access stop order information 2 (bank 3). The priority management unit 122 sets the highest priority (priority 3) to the bank 2, sets the second highest priority (priority 2) to the bank 3, and sets the lowest priority (priority 1) to other unreceived bank regions.

At a time T11, the priority management unit 122 receives, as the access stop order information, information indicating the banks 3 and 4 to be refreshed after the bank 2 from the access stop management unit 111. The priority management unit 122 sets the highest priority (priority 3) to the bank 3, sets the second highest priority (priority 2) to the bank 4, and sets the lowest priority (priority 1) to other unreceived bank regions.

At a time T21, an operation similar to those at the times T11 and T1 is performed.

As described above, an access request to a bank region to be refreshed can be processed with the timing thereof being moved forward. This can reduce the performance decline issue in which the completion of a series of processes is delayed. The access request to a refresh target bank can be processed with the timing thereof being moved forward, so that the capacity of a save buffer can be reduced.

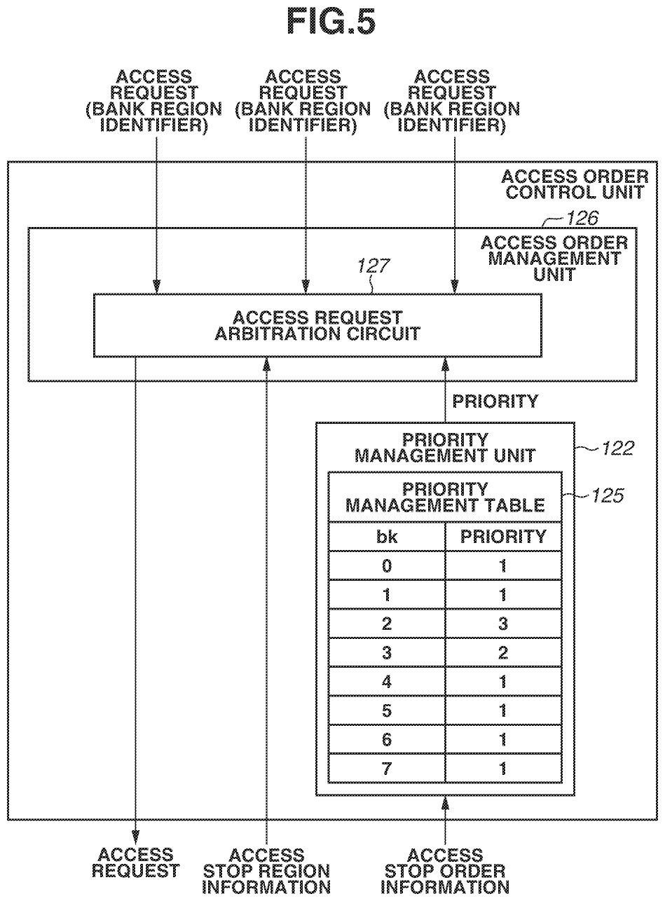

In the present embodiment, the description has been provided of the access order management unit 121 in which one access request is selected from the access request buffer 123, but the configuration of the access order management unit is not limited to this. As in an access order management unit 126 illustrated in FIG. 5, an access request arbitration circuit 127 may be included. In such a case, the access request arbitration circuit 127 receives a plurality of access requests including bank region identifiers, from masters. The access request arbitration circuit 127 then receives a priority from the priority management unit 122, and receives access stop region information indicating a bank region currently being refreshed, from the access stop management unit 111. In accordance with the priority from the priority management unit 122, the access request arbitration circuit 127 selects one access request from among access requests having bank region identifiers other than a bank region identifier of the bank region currently being refreshed, and transfers the selected one access request to the DRAM command issuance unit 130.

A second embodiment of the present disclosure will be described below. In the present embodiment, access stop schedule information will be described as access stop order information as in the first embodiment.

In the first embodiment, the description has been provided of a configuration in which the access stop order information includes bank regions to be refreshed and the order of refreshment of bank regions to be refreshed, and the priority management unit 122 determines a priority in accordance with the order of refreshment of the bank regions to be refreshed.

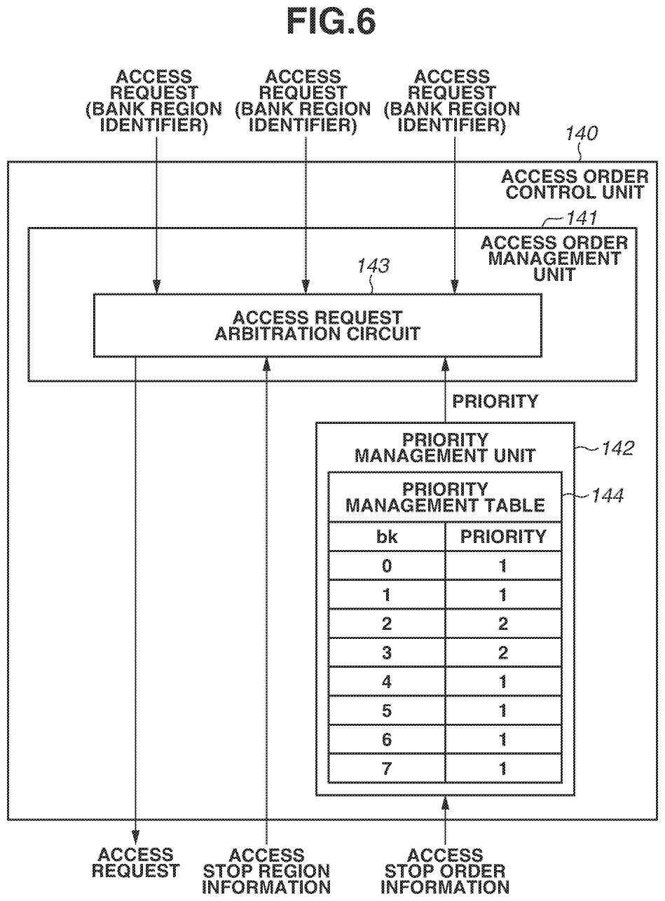

In the second embodiment, a priority management unit has a configuration different from the priority management unit 122 according to the first embodiment. A priority management unit 142 illustrated in FIG. 6 changes priorities of bank regions that are to be refreshed and included in the received access stop order information, to the same priority. In addition, the priority management unit 142 sets the lowest priority to unreceived bank regions. Furthermore, the priority management unit 142 constantly transmits a priority managed in a priority management table 144 to an access order management unit 141, as in the priority management unit 122 according to the first embodiment.

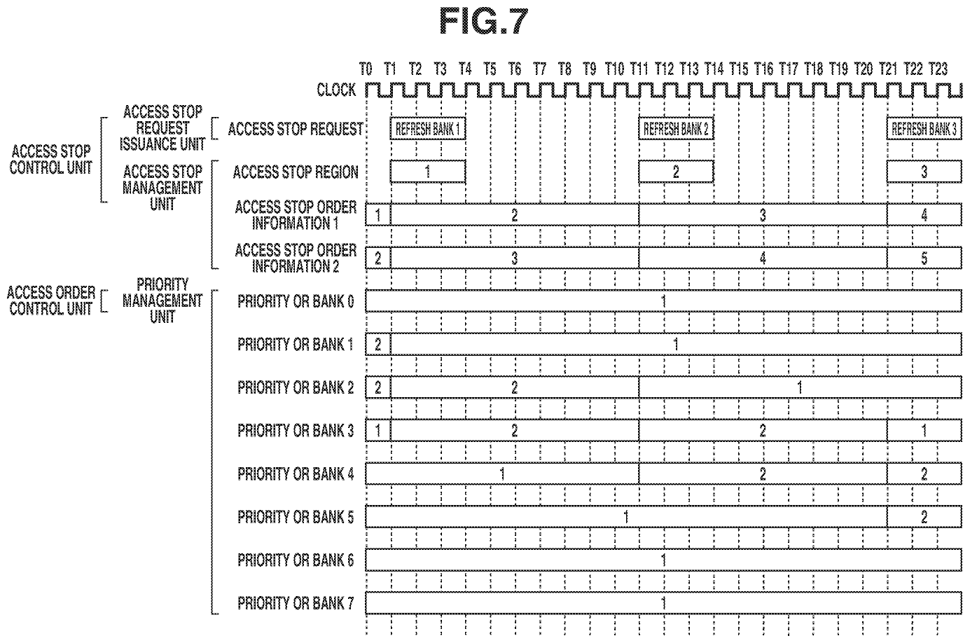

FIG. 7 is a waveform chart illustrating a behavior of a memory bus system according to the second embodiment. In this waveform chart, the access stop management unit 111 of the access stop control unit 110 transmits pieces of access stop order information corresponding to a threshold, to an access order control unit 140. The priority management unit 142 then receives access stop order information, and sets the priorities of the corresponding bank regions to the same priority. In the present embodiment, the description will be provided assuming that the threshold is set to 2.

At a time T1, the access stop target control unit 113 transmits, as the access stop region information, information indicating the bank 1 to the access stop request issuance unit 112, and issues refreshing of the bank 1 to the memory 300 via the DRAM command issuance unit 130. At the same time, the access stop target control unit 113 transmits information indicating the bank 1 as the access stop region information, to the access order control unit 140. Furthermore, the access stop target control unit 113 transmits, as the access stop order information, information indicating the banks 2 and 3 to be refreshed after the bank 1 to the access order control unit 140.

At the time T1, the priority management unit 142 of the access order control unit 140 receives access stop order information 1 (bank 2) and access stop order information 2 (bank 3). The priority management unit 142 sets a high priority (priority 2) to the banks 2 and 3, and sets a low priority (priority 1) to other bank regions.

At a time T11, the priority management unit 142 receives, as the access stop order information, information indicating the banks 3 and 4 to be refreshed after the bank 2, from the access stop management unit 111. The priority management unit 142 sets a high priority (priority 2) to the banks 3 and 4, and sets a low priority (priority 1) to other bank regions.

At a time T21, an operation similar to those at the times T11 and T1 is performed.

In the present embodiment, the access stop management unit 111 transmits information indicating bank regions to be refreshed and the order of refreshment, but may transmit information including only bank regions to be refreshed.

A third embodiment of the present disclosure will be descried below. In the first and second embodiments, the description has been provided assuming that a refresh issuance order is fixed.

The refresh issuance order may sometimes be an optional order. In the present embodiment, an access stop control unit has a configuration different from the access stop control unit 110 according to the second embodiment.

In the third embodiment, a refresh issuance order is an optional order.

In the present embodiment, access stop schedule information includes only bank regions to be refreshed. In the present embodiment, access stop schedule information will be described as access stop target information.

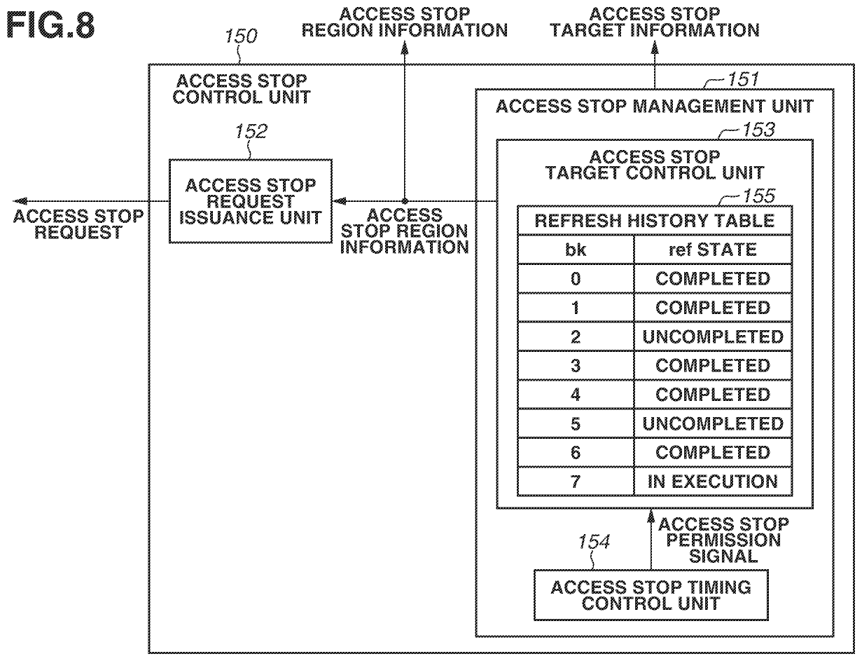

FIG. 8 is a configuration diagram of an access stop control unit 150 according to the third embodiment.

The access stop control unit 150 includes an access stop management unit 151 and an access stop request issuance unit 152. The access stop management unit 151 includes an access stop target control unit 153 and an access stop tinting control unit 154.

The access stop request issuance unit 152 and the access stop timing control unit 154 respectively have configurations similar to the access stop request issuance unit 112 and the access stop timing control unit 114 according to the first embodiment.

The access stop target control unit 153 includes a refresh history table 155. The refresh history table 155 manages a refresh state of each bank region. A refresh issuance order is an optional order. Thus, when an access stop permission signal is received, the access stop target control unit 153 selects one bank region as a refresh target from among bank regions in the refresh history table 155 that have a refresh state of “uncompleted”, through an optional method. The access stop target control unit 153 then updates the refresh state of the selected bank region in the refresh history table 155 to “in execution”, and transmits access stop region information to the access stop request issuance unit 152. Upon the completion of the refreshing, the access stop target control unit 153 updates the refresh state of the selected bank region in the refresh history table 155 to “completed”.

In addition, the access stop target control unit 153 constantly counts the number of banks in the refresh history table 155 that have a refresh state of “uncompleted”. If a count value becomes a predetermined threshold or less, the access stop target control unit 153 transmits, as the access stop target information, information indicating the bank region that has a refresh state of “uncompleted”, to the access order control unit 120.

The priority management unit 122 of the access order control unit 120 receives the access stop target information, and sets a high priority to the bank region that has a refresh state of “uncompleted”, and sets a low priority to the other bank regions.

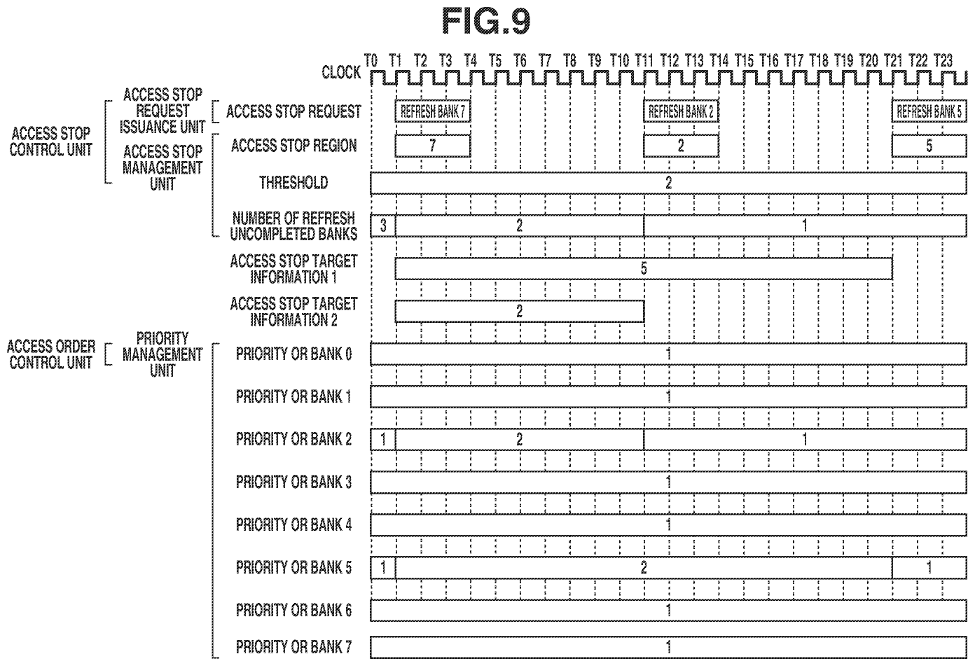

FIG. 9 is a waveform chart illustrating a behavior of a memory bus system according to the third embodiment. In this waveform chart, the access stop control unit 150 transmits pieces of access stop target information corresponding to a threshold, to the access order control unit 120. The priority management unit 122 then receives the pieces of access stop target information, and sets the priorities of the corresponding bank regions to the same priority. In the present embodiment, the description will be provided assuming that the threshold is set to 2.

At a time T1, the access stop target control unit 153 transmits information indicating the bank 7 as the access stop region information to the access stop request issuance unit 152, and issues refreshing of the bank 7 to the memory 300 via the DRAM command issuance unit 130. At the same time, the access stop target control unit 153 updates the refresh state of the bank 7 in the refresh history table 155 to “in execution”, and the number of refresh-uncompleted banks becomes 2 from 3. Since the number of refresh-uncompleted banks becomes the predetermined threshold or less, the access stop target control unit 153 transmits, as the access stop target information, information indicating the remaining banks 2 and 5 in the refresh history table 155 that have a refresh state of “uncompleted”, to the access order control unit 120. The priority management unit 122 receives the access stop target information by performing an operation similar to that in the second embodiment, and then, sets a high priority (priority 2) to the banks 2 and 5, and sets a low priority (priority 1) to other bank regions.

At a T11, the access stop control unit 150 transmits information indicating the bank 2 as the access stop region information. At the same time, the access stop target control unit 153 updates the refresh state of the bank 2 in the refresh history table 155 to “in execution”, and the number of refresh-uncompleted banks becomes 1 from 2. Since the number of refresh uncompleted banks remains smaller than or equal to the predetermined threshold, the access stop target control unit 153 transmits, as the access stop target information, information indicating only the remaining bank 5 in the refresh history table 155 that has a refresh state of “uncompleted”, to the access order control unit 120. The priority management unit 122 receives the access stop target information by performing an operation similar to that at the time T1, and then, sets a high priority (priority 2) to the bank 5, and sets a low priority (priority 1) to other bank regions.

A fourth embodiment of the present disclosure will be described below. In the present embodiment, access stop schedule information includes bank regions to be refreshed, and the order of refreshment of the bank regions to be refreshed. In the present embodiment, access stop schedule information will be described as access stop order information.

In the first to third embodiments, the description has been provided of a configuration of constantly transmitting access stop order information during the period from when refreshing is started to when refreshing of a following bank region is started, that is, during the period from the time T1 to the time T11 and during the period from the time T11 to the time T21, but the configuration is not limited to this.

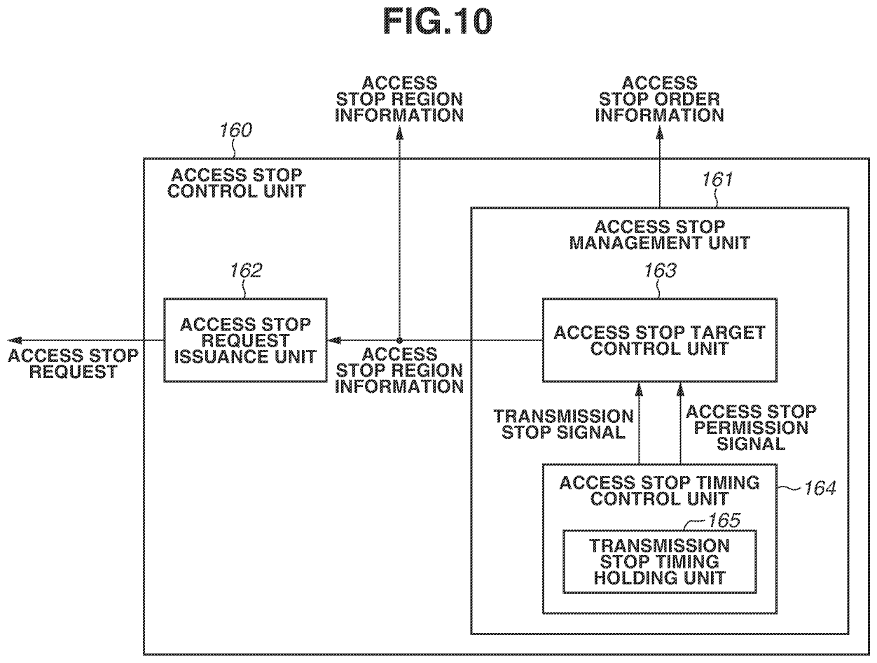

An access stop control unit 160 illustrated in FIG. 10 includes an access stop management unit 161 and an access stop request issuance unit 162.

The access stop request issuance unit 162 has a configuration similar to the access stop request issuance unit 112 according to the first embodiment and the access stop request issuance unit 152 according to the third embodiment.

The access stop management unit 161 includes an access stop target control unit 163 and an access stop timing control unit 164.

The access stop timing control unit 164 includes a counter for measuring a refresh interval, as in the access stop timing control unit 114 according to the first embodiment, and transmits an access stop permission signal to the access stop target control unit 163 each time a refresh interval is measured. Furthermore, the access stop timing control unit 164 includes a transmission stop timing holding unit 165. The transmission stop timing holding unit 165 holds a timing at which the transmission of access stop order information is stopped. If a transmission stop timing comes, the access stop timing control unit 164 transmits a transmission stop signal to the access stop target control unit 163.

The access stop target control unit 163 transmits access stop order information including a bank region to be refreshed next when an access stop permission signal is received, as in the access stop target control unit 113 according to the first embodiment. Furthermore, the access stop target control unit 163 excludes the bank region to be refreshed next from the access stop order information when a transmission stop signal is received.

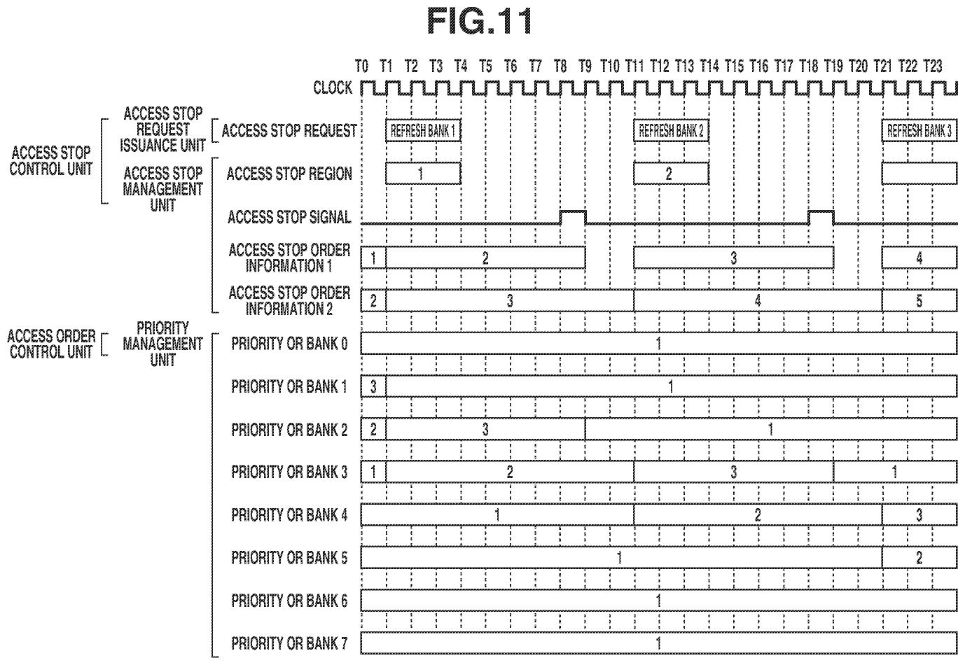

FIG. 11 is a waveform chart illustrating a behavior of a memory bus system according to the fourth embodiment. In the present embodiment, the description will be given assuming that a refresh interval is 10, and a transmission stop timing is 8. On this assumption, refreshing is started at times T1 and T11, and a transmission stop timing comes at times T9 and T19.

At a time T1, the access stop target control unit 163 transmits, as the access stop order information, information indicating the banks 2 and 3 to be refreshed after the bank 1, to the access order control unit 120. The access order control unit 120 receives the access stop order information, sets the highest priority (priority 3) to the bank 2, sets the second highest priority (priority 2) to the bank 3, and sets the lowest priority (priority 1) to unreceived bank regions.

At the time T9, a transmission stop timing comes, and the access stop target control unit 163 excludes the bank 2 to be refreshed after the bank 1, from the access stop order information. Thus, the access order control unit 120 continuously holds the priority (priority 2) of the bank 3, and sets the priorities of unreceived bank regions to the lowest priority (priority 1).

At the time T11, the access stop target control unit 163 transmits, as the access stop order information, information indicating the banks 3 and 4 to be refreshed after the bank 2, to the access order control unit 120. The access order control unit 120 receives the access stop order information, sets the highest priority (priority 3) to the bank 3, sets the second highest priority (priority 2) to the bank 4, and sets the lowest priority (priority 1) to unreceived bank regions.

At the time T19, a transmission stop timing comes, and the access stop target control unit 163 excludes the bank 3 to be refreshed after the bank 2, from the access stop order information. The access order control unit 120 continuously holds the priority (priority 2) of the bank 4, and sets the priorities of unreceived bank regions to the lowest priority (priority 1).

While various embodiments have been described, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2019-070784, filed Apr. 2, 2019, which is hereby incorporated by reference herein in its entirety.

What is claimed is:

1. An access management apparatus for managing an access to a memory, the memory including a plurality of access regions in which an access stop period is regularly generated, and the access management apparatus comprising:
an acquisition unit configured to acquire schedule information for the access stop period; and
a transmission unit configured to select one access request from among a plurality of access requests to the memory based on the schedule information, and transmit the selected access request to the memory.

2. The access management apparatus according to claim 1, wherein the plurality of access regions are bank regions.

3. The access management apparatus according to claim 1, wherein the access stop period is a period in which the plurality of access regions is refreshed.

4. The access management apparatus according to claim 1, wherein the schedule information includes an access region for which an access is to be stopped.

5. The access management apparatus according to claim 4, wherein the schedule information includes an order of stop.

6. The access management apparatus according to claim 5, wherein the transmission unit determines priorities of the plurality of access requests to the memory based on the order of stop, and selects the one access request based on the priorities.

7. The access management apparatus according to claim 4, wherein the transmission unit determines priorities of the plurality of access requests to the memory based on the access region for which an access is to be stopped, and selects the one access request from among the plurality of access requests based on the priorities.

8. The access management apparatus according to claim 4, wherein, in a case where the number of access regions in which an access stop period is not generated becomes a threshold or less, an access region in which an access stop period is not generated is determined as the access region for which an access is to be stopped and that is included in the schedule information.

9. The access management apparatus according to claim 8, wherein the threshold is lower than the number of access regions.

10. The access management apparatus according to claim 7, wherein the transmission unit selects the one access request by using a process wherein access points are selected in a descending order of priority, and in a case where the priorities of two access points are the same, the transmission unit selects the one access request based on an order in which the two access requests are stored.

11. The access management apparatus according to claim 1, wherein the transmission unit is a bus system configured to select one access request from a buffer.

12. The access management apparatus according to claim 1, wherein the transmission unit is an arbitration circuit configured to select one access request from among the plurality of access requests.

13. An access management method for managing an access to a memory including a plurality of access regions in which an access stop period is regularly generated, the access management method comprising:
acquiring schedule information for the access stop period; and
selecting one access request from among a plurality of access requests to the memory based on the schedule information, and transmitting the selected access request to the memory.

14. The access management method according to claim 13, wherein the plurality of access regions are bank regions.

15. The access management method according to claim 13, wherein the access stop period is a period in which the plurality of access regions is refreshed.

16. The access management method according to claim 13, wherein the schedule information includes an access region for which an access is to be stopped.

17. The access management method according to claim 16, wherein the schedule information includes an order of stop.

18. The access management method according to claim 17, wherein, in the transmitting, priorities of the plurality of access requests to the memory are determined based on the order of stop, and the one access request is selected based on the priorities.

19. The access management method according to claim 16, wherein, in the transmitting, priorities of the plurality of access requests to the memory are determined based on the access region for which an access is to be stopped, and the one access request is selected from among the plurality of access requests based on the priorities.

20. The access management method according, to claim 16, wherein, in a case where the number of access regions in which an access stop period is not generated becomes a threshold or less, an access region for which an access stop period is not generated is determined as the access region for which an access is to be stopped and that is included in the schedule information.
